(19) United States
(12) Patent Application Publication
(10) Pub. No.: US 2006/0098407 A1
(43) Pub. Date: May 11, 2006

(54) Docking station for handheld electronic devices

(76) Inventor: Cheng-Hua Hsu, Taipei (TW)

Correspondence Address: RABIN & BERDO, P.C., Suite 500, 1101 14th Street, N.W., Washington, DC, 20005, US

(21) Appl. No.: 11/025,048

(22) Filed: Dec. 30, 2004

(30) Foreign Application Priority Data
Nov. 9, 2004 (TW) 93217908

(51) Int. Cl. G06F 1/16

(52) U.S. Cl. 361/686; 710/303

(57) ABSTRACT

A docking station for handheld electronic devices includes a body which includes a guiding assembly having a first anchor member, and a holding section, and a sliding bracing cap which is movably mounted onto the body, and includes a driven member and a second anchor member respectively corresponding to the guiding assembly, and the first anchor member. The sliding bracing cap may be moved through the driven member along the guiding assembly to a retracted position, where the sliding bracing cap rests on the holding section to brace a handheld electronic device equipped with a back cartridge, and a bracing position, where the sliding bracing cap is anchored through the first and the second anchor members to brace a handheld electronic device without a back cartridge. Hence the device, either with or without a back cartridge, may be mounted securely onto the docking station of the structure without affecting transmission.

### FIELD OF THE INVENTION

The invention relates to a docking station adopted for use on handheld electronic devices, and particularly to a docking station for securely holding a handheld electronic device either with or without a back cartridge.

### BACKGROUND OF THE INVENTION

With the continuous advance of technology, electronic devices have become indispensable products in people's lives. These electronic devices include computers, audio systems, personal digital assistants, digital video and audio optical disk drives, and the like. They provide a wide variety of functions to meet user's different requirements. Vendors also continuously invest in research and development to improve the function and performance of these electronic devices and make usage of these electronic products more convenient.

While providing more functions and powerful performance are important, user-friendliness and portability also are important issues in the design of electronic devices. Hence portable or handheld electronic devices have been developed and introduced. Some handheld electronic devices serve as personal digital assistants. Their capabilities have expanded from the original basic functions of calendar, to-do list, notebook, and communication directory to synchronous data communication with computers. Some even have software installed to provide diversified applications such as online Email receiving and transmission, stock information quotation and browsing, income and payment recording, electronic book function, computer games, spread sheet functions, database applications, household and community information, wireless communication, and the like. When used properly, they provide even greater value to users than general personal assistants.

In order to expand the function of the handheld electronic devices, some of them have become equipped with a back cartridge. Due to design constraints, when transmission is desired, some docking stations can only accept the handheld electronic devices with the back cartridge removed, while other docking stations can only accept the handheld electronic devices with the back cartridge attached. This creates inconvenience to users.

### SUMMARY OF THE INVENTION

In view of the aforesaid problems, the primary object of the invention is to provide a docking station for handheld electronic devices that can securely hold a handheld electronic device either with or without a back cartridge for transmission (such as electrical or data transmission).

In order to achieve the foregoing object, the docking station for handheld electronic devices according to the invention includes a body and a sliding bracing cap. The body includes a guiding assembly and a holding section. The guiding assembly has a first anchor member. The sliding bracing cap is movably mounted onto the body and has a driven member corresponding to the guiding assembly, and a second anchor member corresponding to the first anchor member. The sliding bracing cap is movable through the driven member along the guiding assembly to reach a retracted position and a bracing position. At the retracted position, the sliding bracing cap rests on the holding section to brace a handheld electronic device equipped with a back cartridge. At the bracing position, the sliding bracing cap is anchored through the first and the second anchor members to brace a handheld electronic device without a back cartridge.

Thus by means of the invention a handheld electronic device, either with or without a back cartridge, may be mounted onto the docking station to perform transmission (for electrical or data transmission or the like). The design of the sliding bracing cap enables the handheld electronic device to be held securely without affecting the transmission.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention;

FIG. 2A is a schematic view of the sliding bracing cap at a retracted position;

FIG. 2B is a schematic view of the sliding bracing cap at a bracing position;

FIG. 3A is a schematic view of the sliding bracing cap at a retracted position to hold a handheld electronic device without a back cartridge; and

FIG. 3B is a schematic view of the sliding bracing cap at a bracing position to hold a handheld electronic device with a back cartridge.

### DESCRIPTION OF THE PREFERRED EMBODIMENT

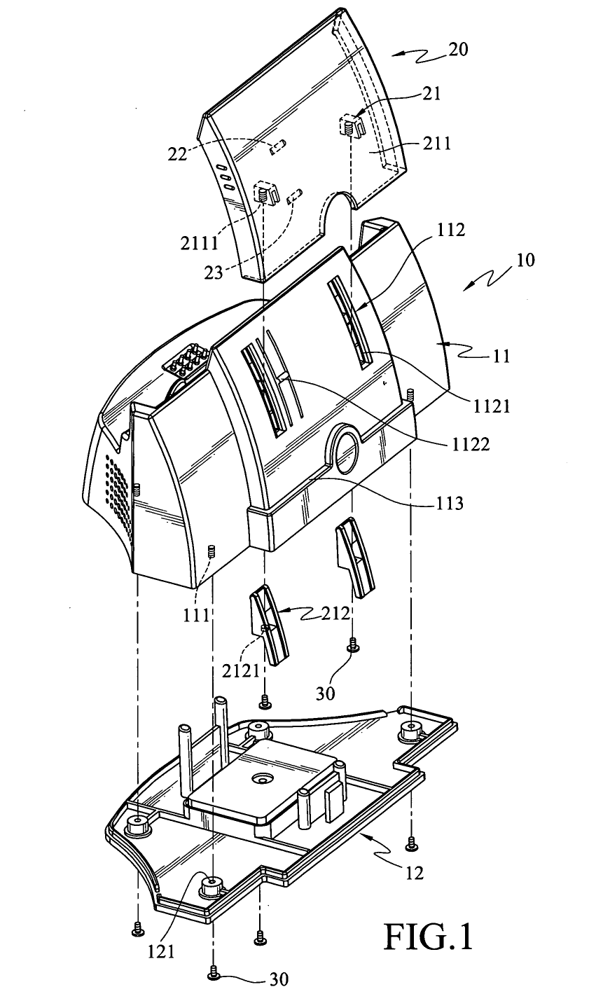

Referring to FIG. 1, the docking station for handheld electronic devices according to the invention includes a body 10 and a sliding bracing cap 20. The body 10 consists of an upper case 11 and a lower case 12. The upper case 11 has a screw hole 111. The lower case 12 has a fastening hole 121 corresponding to the screw hole 111 to receive a fastening element 30 and couple the upper case 11 with the lower case 12.

The upper case 11 further has a guiding assembly 112 and a holding section 113. The guiding assembly 112 includes a guiding track 1121 and a first anchor member 1122, which is a bulged spot.

The sliding bracing cap 20 is movably mounted onto the body 10, and includes a driven member 21, a second anchor member 22 and a third anchor member 23. The driven member 21 corresponds to the guiding assembly 112, and includes a lid 211 and sliding tracks 212 located on two sides of the guiding track 1121. The lid 211 and the sliding tracks 212 have respectively a screw hole 2111 and a fastening hole 2121 to couple with a fastening element 30. The second anchor member 22 and the third anchor member 23 are notches corresponding to the first anchor member 1122.

For assembly, place the sliding bracing cap 20 on one side of the body 10 where the guiding track 1121 is located, place the sliding tracks 212 on another side of the body 10, and fasten the sliding bracing cap 20 and the sliding tracks 212 to two ends of the guiding track 1121 by coupling the fastening element 30 through the screw hole 2111 and the fastening hole 2121. Then couple the upper case 11 with the lower case 12 through the fastening element 30, screw hole 111 and fastening hole 121.

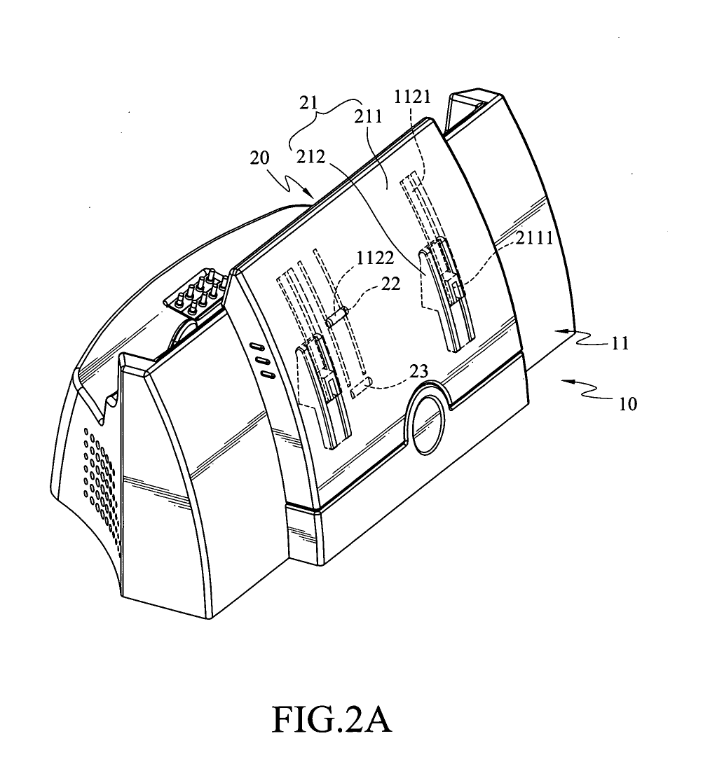

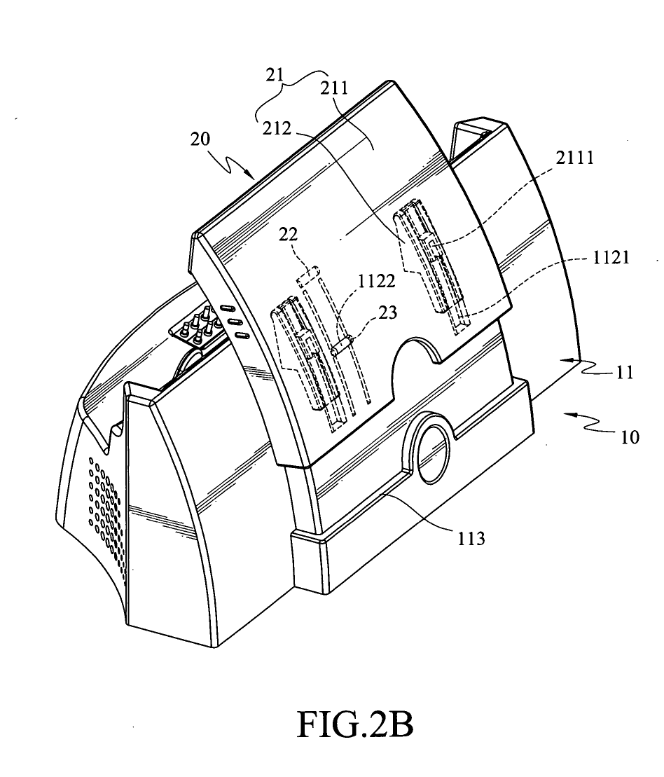

Refer to FIG. 2A for the sliding bracing cap at a retracted position, and FIG. 2B for the sliding bracing cap at a bracing position. After assembly of the invention has been completed, the sliding bracing cap 20 may be moved through the driven member 21 along the guiding assembly 112 to reach the retracted position and the bracing position. At the retracted position, the sliding bracing cap 20 rests on the holding section 113, and the first anchor member 1122 is coupled with the third anchor member 23 for anchoring. At the bracing position, the bracing cap 20 is anchored by the coupling of the first anchor member 1122 and the second anchor member 22.

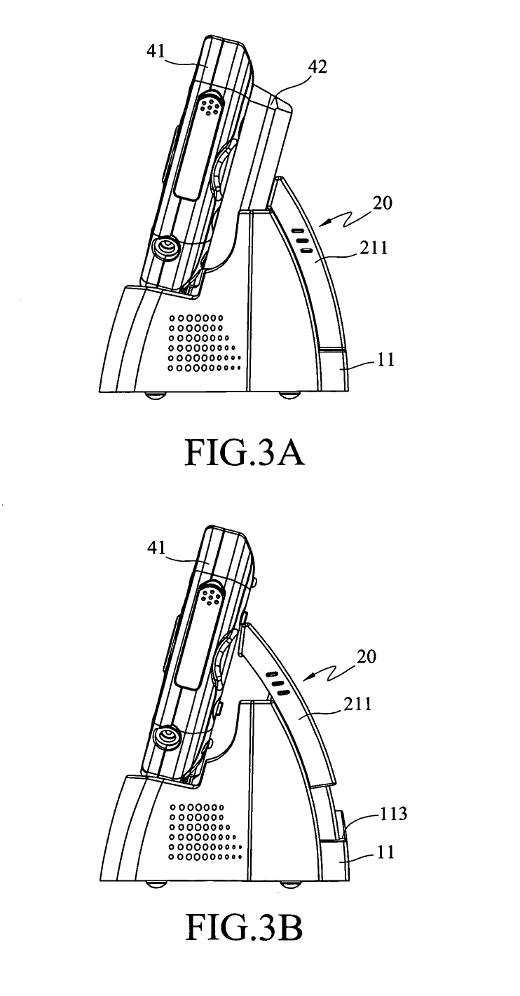

Refer to FIG. 3A for the sliding bracing cap at the retracted position to hold a handheld electronic device without a back cartridge, and FIG. 3B for the sliding bracing cap at the bracing position to hold a handheld electronic device with a back cartridge. When the sliding bracing cap 20 is at the retracted position, it can brace a handheld electronic device 41 with a back cartridge 42. When the sliding bracing cap 20 is at the bracing position, it can brace a handheld electronic device 41 without a back cartridge 42.

Thus whether the handheld electronic device 41 is equipped with a back cartridge 42 or not, it may be mounted onto the docking station of the invention to perform transmission (for electricity or data). The design of the sliding bracing cap 20 enables the handheld electronic device 41 to be held securely on the docking station without affecting transmission.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A docking station for handheld electronic devices, comprising:
a body including a guiding assembly and a holding section, and the guiding assembly having a first anchor member; and
a sliding bracing cap which is movably mounted onto the body includes a driven member corresponding to the guiding assembly and a second anchor member corresponding to the first anchor member;
wherein the sliding bracing cap is movable through the driven member along the guiding assembly to a retracted position and a bracing position, at the retracted position the sliding bracing cap resting on the holding section to brace a handheld electronic device equipped with a back cartridge, and at the bracing position the sliding bracing cap being anchored through the first anchor member and the second anchor member to brace the handheld electronic device without the back cartridge.

2. The docking station for handheld electronic devices of claim 1, wherein the body includes an upper case and a lower case, the guiding assembly being located on the upper case.

3. The docking station for handheld electronic devices of claim 2, wherein the upper case includes a screw hole, and the lower case includes a fastening hole corresponding to the screw hole to receive a fastening element to couple the upper case with the lower case.

4. The docking station for handheld electronic devices of claim 1, wherein the first anchor member is a bulged spot, and the second anchor member is a notch.

5. The docking station for handheld electronic devices of claim 1, wherein the guiding assembly includes a guiding track, and the driven member includes a lid and a sliding track located on two sides of the guiding track, the lid and the sliding track have respectively a screw hole and a fastening hole coupled together through a fastening element.

6. The docking station for handheld electronic devices of claim 1, wherein the sliding bracing cap further has a third anchor member corresponding to the first anchor member, the third anchor member being a notch to couple with the first anchor member to anchor the sliding bracing cap at the bracing position.
